(19) United States
(12) Patent Application Publication
(10) Pub. No.: US 2013/0044189 A1
(43) Pub. Date: Feb. 21, 2013

(54) IMAGING APPARATUS

(71) Applicants: Miyoko IRIKIIN, Hyogo (JP); Yasuo YOKOTA, Osaka (JP); Makoto IYODA, Osaka (JP); Tomonori MIZUTANI, Osaka (JP); Yasuhiro MIYAMOTO, Osaka (JP)

(72) Inventors: Miyoko IRIKIIN, Hyogo (JP); Yasuo YOKOTA, Osaka (JP); Makoto IYODA, Osaka (JP); Tomonori MIZUTANI, Osaka (JP); Yasuhiro MIYAMOTO, Osaka (JP)

(21) Appl. No.: 13/613,556

(22) Filed: Sep. 13, 2012

Related U.S. Application Data
(63) Continuation of application No. PCT/JP2011/007049, filed on Dec. 16, 2011.

(30) Foreign Application Priority Data
Jul. 26, 2011 (JP) 2011-162733

(51) Int. Cl. H04N 13/02

(52) U.S. Cl. 348/47; 348/E13.074; 348/E13.004

(57) ABSTRACT

An imaging apparatus includes a plurality of imaging units, and a radiator operable to uniformize temperatures of the plurality of the imaging units.

### CROSS-REFERENCE TO RELATED APPLICATIONS

This is a continuation application of International Application No. PCT/JP2011/007049, with an international filing date of Dec. 16, 2011, which claims priority of Japanese Patent Application No.: 2011-162733 filed on Jul. 26, 2011, the content of which is incorporated herein by reference.

### BACKGROUND

1. Technical Field

The technical field relates to an imaging apparatus having a plurality of imaging units.

2. Related Art

In a digital camera of recent years, power consumption of an image sensor and a camera controller increases because of compatibility with high image quality and video shooting, and thus a heating value in the image sensor and the camera controller becomes large.

JP-A-2008-167066 discloses a digital camera as an imaging apparatus having a plurality of imaging units. The digital camera disclosed in JP-A-2008-167066 has two optical systems and imaging devices such as two CCDs for capturing stereoscopic images (3D images) that are stereoscopically viewable, and can capture images of one subject from two view points of right and left.

Such a digital camera has two imaging units, each of imaging units including an optical system and an imaging device. Thus, heating value in the imaging unit becomes twice as large as that in a digital camera having only one imaging unit. Further, the heating value in the camera controller that processes captured images becomes comparatively large.

### SUMMARY

In a digital camera having a plurality of imaging units, when temperature is different between two imaging units, difference of a way of generating a noise component occurs. Thus, difference of image quality occurs, and further quality of a stereoscopic image configured by the two images captured by two imaging units is deteriorated.

One non-limiting and exemplary embodiment provides an imaging apparatus having a plurality of imaging units that can prevent deterioration in quality of an image which is caused by a difference of temperature between the imaging units.

In order to achieve such an object, an imaging apparatus of the present disclosure has a plurality of imaging units and a radiator operable to uniformize temperatures of the imaging units.

The radiator may be, for example, a thermally-conductive member for thermally connecting the plurality of imaging units mutually.

The radiator may have thermally-conductive members that are joined to the plurality of imaging units, respectively, and connecting members which has flexibility and thermally connecting the thermally-conductive members.

The radiator may have thermally-conductive members that are thermally joined to the plurality of imaging units, and a fan. The fan generates a current of air between a plurality of imaging units to simultaneously cool the thermally-conductive members joined to the plurality of imaging units.

According to the present disclosure, in the imaging apparatus having a plurality of imaging units, the temperatures in the plurality of imaging units are uniformized. Thus, an amount of noise included in electric signals output from the plurality of image sensors is uniformized. As a result, deterioration in image quality of a stereoscopic image which is caused by a difference of temperature between the imaging units can be prevented.

### BRIEF DESCRIPTION OF THE DRAWINGS

FIG. 1 is a perspective view illustrating a digital camera according to a first embodiment.

FIG. 2 is a perspective view illustrating an internal constitution from which a front case is removed in FIG. 1.

FIG. 3 is a schematic diagram describing a detailed constitution of an imaging unit.

FIG. 4 is a schematic diagram illustrating mainly a configuration of a circuit block.

FIGS. 5A and 5B are schematic diagrams illustrating an arrangement of a thermally-conductive member and two imaging units.

FIG. 6 is a front view illustrating an arrangement of the thermally-conductive member and the two imaging units.

FIG. 7 is a cross-sectional view illustrating a constitution of main section of the imaging unit.

FIG. 8 is a front view illustrating the two imaging units that are connected by a flexible connecting member.

FIG. 9 is a perspective view illustrating an internal constitution of the digital camera according to a third embodiment.

FIG. 10 is a perspective view illustrating an internal constitution of the digital camera according to a fourth embodiment.

### DETAILED DESCRIPTION

### 1. First Embodiment

1-1. Entire configuration of Imaging Apparatus

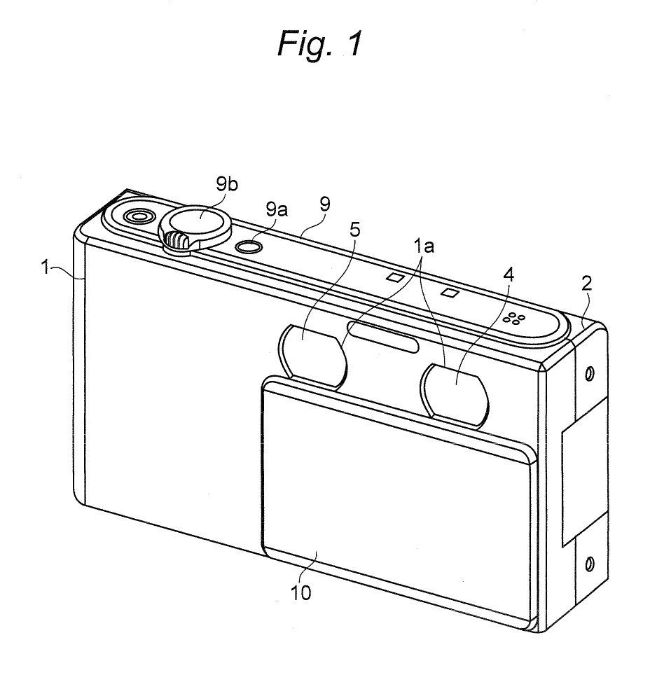

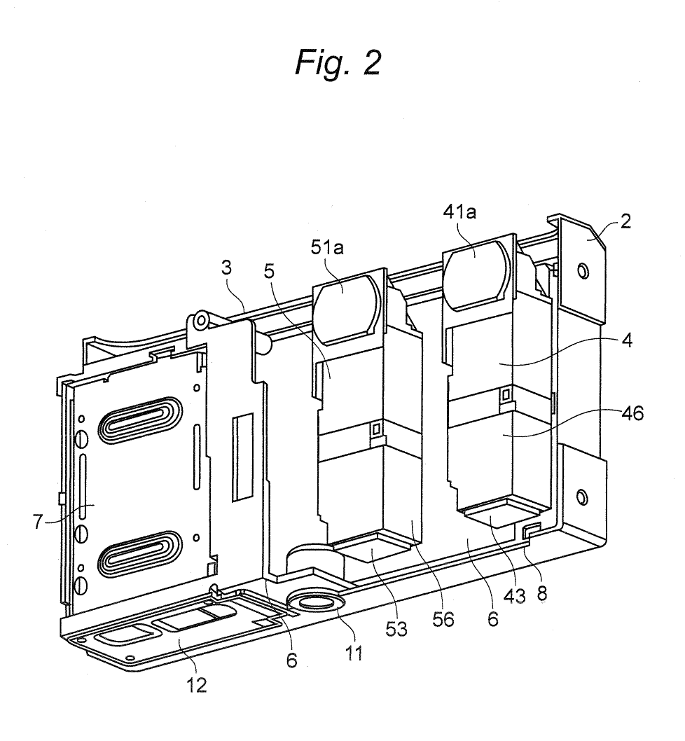

A digital camera is described below as one example according to an embodiment of the present disclosure. FIG. 1 is a perspective view illustrating the digital camera according to the embodiment. FIG. 2 is a perspective view illustrating an internal constitution from which a front case is removed in FIG. 1.

As shown in FIGS. 1 and 2, the digital camera is constituted so that a camera body 3 is housed in an exterior case having a front case 1 and a rear case 2. The digital camera according to the embodiment can capture a stereoscopic image that can be stereoscopically viewed. The camera body 3 has a first imaging unit 4 and a second imaging unit 5. The first imaging unit 4 and the second imaging unit 5 are mounted to a metal frame 6 inside the exterior case at an interval. Further, the camera body 3 has a power-supply block 7 that houses a battery (not shown) to be a power supply of the digital camera, and a circuit block 8 for controlling an operation of the camera body 3. The power-supply block 7 and the circuit block 8 are arranged in a space in the exterior case. The power-supply block 7 supplies a power which is to be used in the camera body 3, to respective units of the digital camera. The power-supply block 7 houses a battery inside, and includes a power-supply terminal to which a power-supply adaptor for converting an AC power to a DC power is connected.

Further, in the camera body 3, the first imaging unit 4 is arranged at an end portion of the exterior case (in FIG. 1, a right end), and the second imaging unit 5 is arranged at an approximately center portion of the exterior case. The first imaging unit 4 is an imaging unit that is always driven at a time of capturing an image in the digital camera. The second imaging unit 5 is an imaging unit that is driven only when a stereoscopic image is captured.

Further, an operating unit 9 including a main power switch 9a and a release button 9b is provided on an upper-surface portion of the exterior case. A slide cover 10 which is slidable up and down for opening and closing photographing windows la of the first imaging unit 4 and the second imaging unit 5 is arranged in the front case 1. A supporter receptacle 11 is arranged on a bottom portion of the exterior case so as to be exposed to the outside. The supporter receptacle 11 is made of metal such as stainless alloy, and is used for installing the digital camera to a supporter such as a tripod or a monopod. The supporter receptacle 11 is fixed to the frame 6. Only a portion which is to be fixed to the supporter such as the tripod or the monopod is exposed from the bottom portion of the exterior case.

Further, a cover 12 for opening and closing an opening through which the battery is housed in the internal space of the power-supply block 7 is provided on a bottom portion of the rear case 2 configuring the exterior case. A user of the digital camera can open and close the cover 12, to attach and detach the battery to and from the power-supply block 7.

### 1-2. Configuration of Imaging Unit

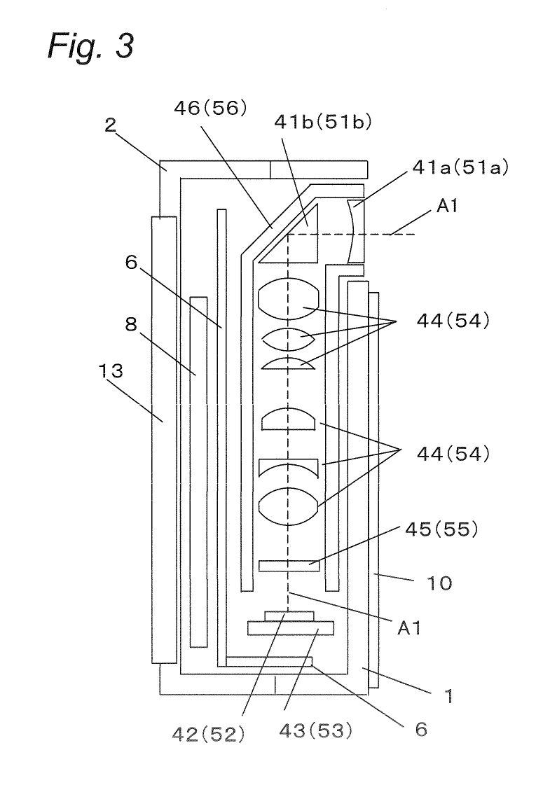

FIG. 3 is a schematic constitutional diagram of the digital camera describing a constitution of the first imaging unit 4 or the second imaging unit 5 in detail. The first imaging unit 4 and the second imaging unit 5 have the same constitution.

As shown in FIGS. 1 and 2, the first imaging unit 4 and the second imaging unit 5 are arranged on an upper portion of the front case 1 opposed to the photographing windows la.

As shown in FIG. 3, each of the first imaging unit 4 and the second imaging unit 5 includes a lens unit, an image sensor 42(52), a circuit board 43(53), a lens group 44(54), a diaphragm unit 45(55), and a unit housing 46(56).

The lens unit includes a lens 41a(51a) for receiving an optical image A1 of a subject through the photographing windows 1a, and a flectional optical system 41b(51b) for leading an incident optical image A1 to the image sensor 42(52).

The image sensor 42(52) is arranged on a lower portion of the imaging unit, and converts the optical image A1 received by the lens unit into image data. The image sensor 42(52) is mounted on the circuit board 43(53), and includes, for example, CMOS.

A circuit for controlling the image sensor 42(52) and processing the image data obtained from the image sensor 42(52) is mounted on the circuit board 43(53).

The lens group 44(54) and the diaphragm unit 45(55) are arranged between the lens unit and the image sensor 42(52).

The unit housing 46(56) houses parts which configure the first imaging unit 4 (the second imaging unit 5).

A camera monitor 13 including a liquid crystal display is arranged on a rear surface of the rear case 2.

### 1-3. Circuit Block

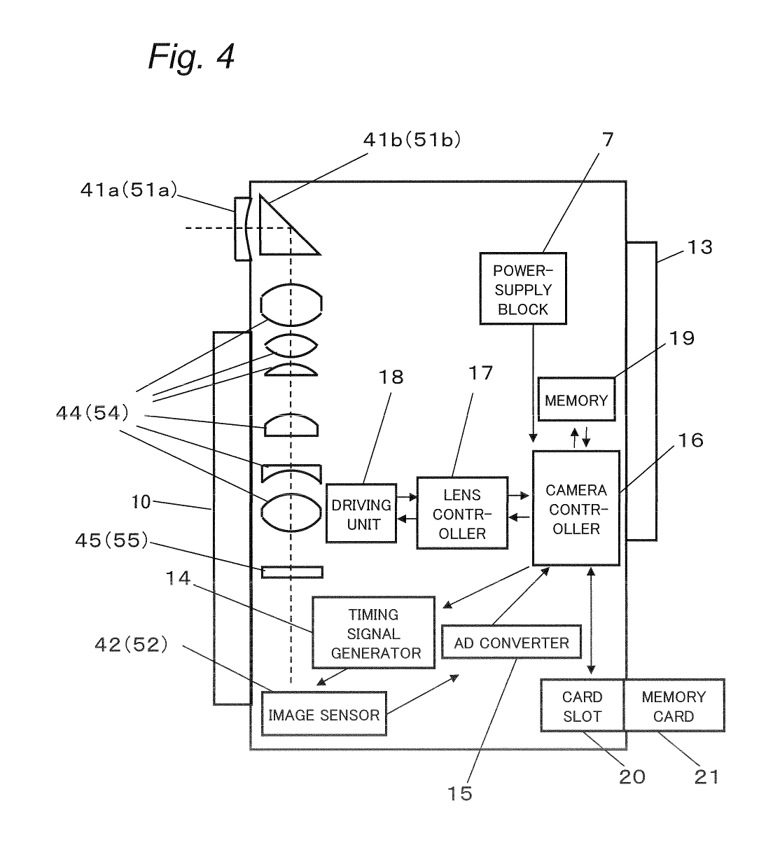

A constitution of the circuit block 8 of the camera body 3 and its operation are described. FIG. 4 is a schematic diagram illustrating the constitution of the circuit block 8 for controlling the operation of the camera body 3.

The circuit block 8 includes a camera controller 16, a lens controller 17, a driving unit, and a memory 19. A timing signal generator 14 and an AD converter 15 are mounted on the circuit board 43(53) of the first imaging unit and the second imaging unit.

The image sensor 42(52) converts an optical image of a subject which is incident via the lens unit, into image data such as still image data and moving image data. The image sensor 42(52) operates based on a timing signal from the timing signal generator 14 mounted on the circuit board 43(53) to convert the optical image into image data.

The image data converted by the image sensor 42(52) is converted into a digital signal by the AD converter 15 mounted on the circuit board 43(53), and is sent to the camera controller 16, then is subject to image processes. Examples of the image processes are a gamma correcting process, a white balance correcting process, a scratch correcting process, a YC converting process, an electronic zoom process, and a JPEG compressing process.

The camera controller 16 accepts an instruction from the operating unit 9 to control the respective units of the camera body 3. Concretely, the camera controller 16 transmits signals for controlling the first imaging unit 4 and the second imaging unit 5 to the lens controller 17, and receives various signals from the lens controller 17. The driving unit 18 drives the respective lens groups (a zoom lens group, an OIS lens group, and a focus lens group) of the optical systems in the first imaging unit 4 and the second imaging unit 5, and controls the diaphragm units 45(55) based on the control signal of the lens controller 17. The diaphragm unit 45(55) is a light amount adjusting member for adjusting an amount of light transmitting thorough the optical system.

When the camera controller 16 controls a driving of the respective lens groups and the diaphragm units 45(55) of the first imaging unit 4 and the second imaging unit 5, the memory 19 is used when the camera controller 16 temporarily saves data, and saves programs and parameters for controlling the camera controller 16.

A memory card 21 is detachably attached into a card slot 20. The card slot 20 controls the memory card 21 based on a control signal transmitted from the camera controller 16, and writes and reads still image data and moving image data obtained from the image sensor 42(52). Further, the card slot 20 is provided in a space where the power-supply block 7 is arranged, in the exterior case. When the cover 12 for attaching and detaching a battery is open, the memory card 21 can be attached into and detached from the card slot 20.

The moving image data generated by the image sensor 42(52) is used also for displaying a through image. The through image is a moving image that is not recorded as moving image data in the memory card 21. The through image is subject to the image process in the camera controller 16, and is displayed on the camera monitor 13 so that a user determines a composition of a moving image or a still image.

### 1-4. Connection via Radiation Plate

The digital camera according to this embodiment can capture a stereoscopic image (3D image) and a non-stereoscopic image (2D image). The digital camera according to this embodiment drives the first imaging unit 4 and the second imaging unit 5 at a time of capturing a stereoscopic image to capture two non-stereoscopic images by photographing a subject at different angles. The two non-stereoscopic images photographed at different angles are used to configure a stereoscopic image that can be stereoscopically viewed. Further, the digital camera according to this embodiment drives only the first imaging unit 4 at the time of capturing the non-stereoscopic image to capture one non-stereoscopic image.

When the first imaging unit 4 and the second imaging unit 5 are driven, they generate heat. A great amount of heat is generated particularly from the image sensors 42 and 52. The higher the temperatures of the image sensors 42 and 52 become, the larger amounts of noise in the electric signals output from the image sensors 42 and 52 are.

The first imaging unit 4 drives at both the time of capturing a stereoscopic image and at the time of capturing a non-stereoscopic image, but the second imaging unit 5 drives only at the time of capturing a stereoscopic image. Since frequency of use of the first imaging unit 4 is high, the temperature of the first imaging unit 4 easily becomes higher than the temperature of the second imaging unit 5. For this reason, a difference of temperature between the first imaging unit 4 and the second imaging unit 5 is easily caused.

When the difference of temperature becomes large between the first imaging unit 4 and the second imaging unit 5, difference of an amount of noise included in electric signals output from the image sensors 42 and 52 occurs, difference between images generated by the respective imaging units occurs, and thus image quality of the stereoscopic image including these images is deteriorated. Therefore, in order to prevent the deterioration in the image quality of a stereoscopic image caused by the difference of temperature between the first imaging unit 4 and the second imaging unit 5, the digital camera according to this embodiment has means for uniformizing the temperatures of the first imaging unit 4 and the second imaging unit. This means is concretely described below.

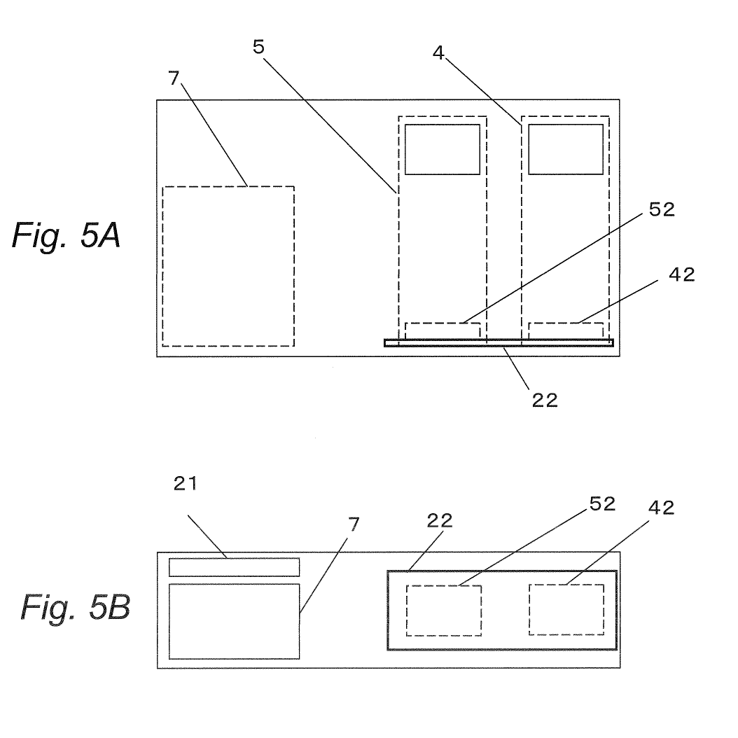

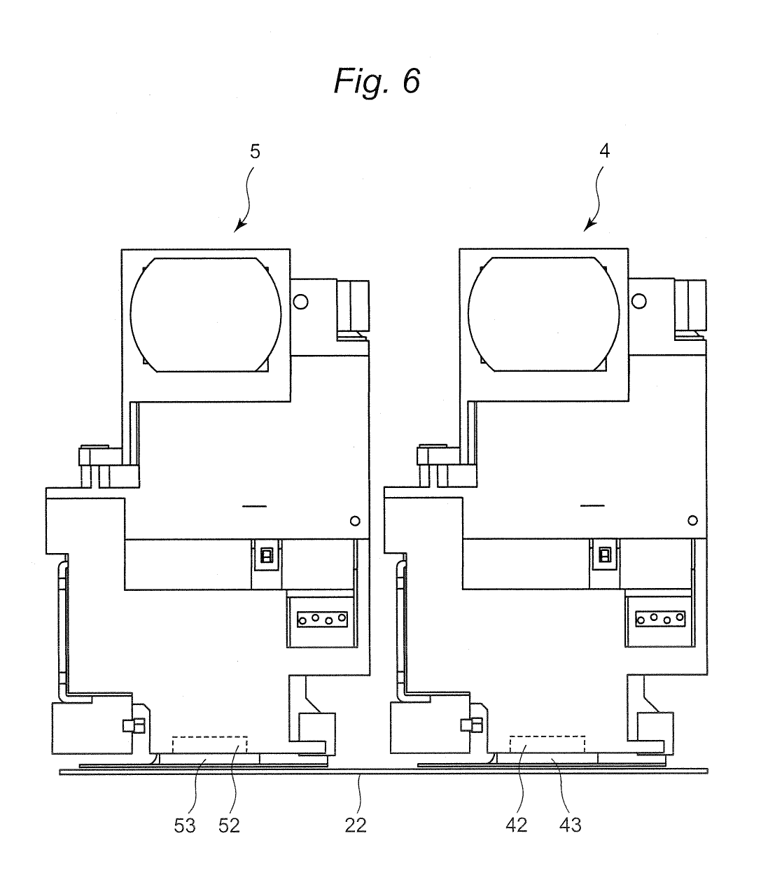

FIGS. 5A, 5B and 6 are schematic diagrams illustrating an arrangement of the first imaging unit 4 and the second imaging unit 5 in the digital camera according to this embodiment. FIG. 5A is the diagram viewed from a front, and FIG. 5B is the diagram viewed from a bottom.

As shown in FIGS. 5A, 5B and 6, the digital camera according to this embodiment has a radiation plate 22 as a thermally-conductive member for conducting heat generated in the image sensors 42 and 52 of the first imaging unit 4 and the second imaging unit 5. The radiation plate 22 thermally connects the first imaging unit 4 and the second imaging unit 5. The radiation plate 22 is, for example, one aluminum plate.

Further, in the exterior case, the memory card 21 is arranged in an internal space in which the power-supply block 7 is arranged.

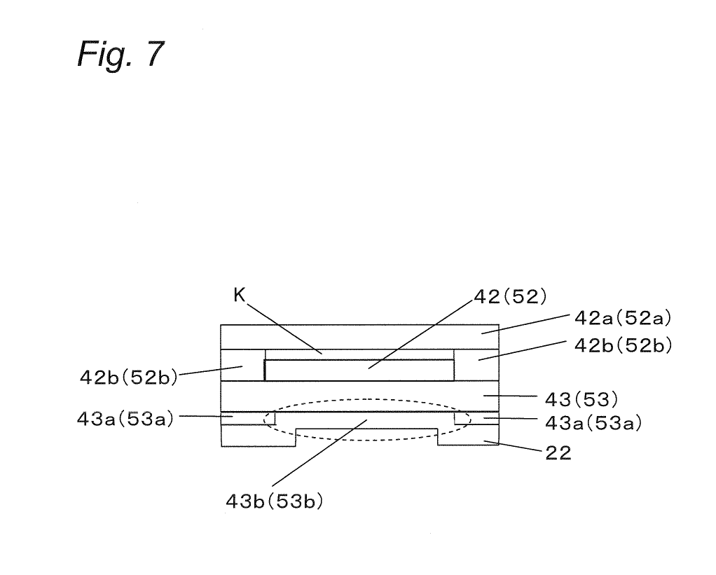

FIG. 7 is a cross-sectional view illustrating a constitution of a main section of the first imaging unit 4 or the second imaging unit 5. As shown in FIG. 7, a glass plate 42a(52a) is arranged with a space K on an upper surface of the image sensor 42(52) and thereon, and the periphery of the image sensor 42(52) is sealed by a sealing resin 42b(52b). Further, a flexible wiring board 43a(53a) is joined to the circuit board 43(53) in order to connect the circuit board 43(53) to the circuit block 8.

The radiation plate 22 is joined to the flexible wiring board 43a(53a) which is joined to the circuit board 43(53) having the image sensors 42(52) by an adhesive member (not shown) having electrical insulation property and thermal conductivity. Further, an opening 43b(53b) is formed on the flexible wiring board 43a(53a) so that the radiation plate 22 directly contacts with the circuit board 43(53).

Heat is conductive between the first imaging unit 4 and the second imaging unit 5 by the radiation plate 22, and the temperatures of the first imaging unit 4 and the second imaging unit 5 are uniformized. The uniformizing of the temperatures reduces the difference in the amount of noise output from the image sensors 42 and 52, and thus the deterioration in the image quality of a stereoscopic image caused by the difference of temperature between the imaging units is prevented.

### 1-5. Conclusion

In the digital camera according to this embodiment, the difference of temperature between the first imaging unit 4 and the second imaging unit 5 is reduced by connecting the first imaging unit 4 and the second imaging unit 5 with the radiation plate 22. The difference between the amount of noise output from the image sensors 42 and 52 is reduced, and the deterioration in the image quality of a stereoscopic image caused by the difference of temperature between the imaging units is prevented.

### 2. Second Embodiment

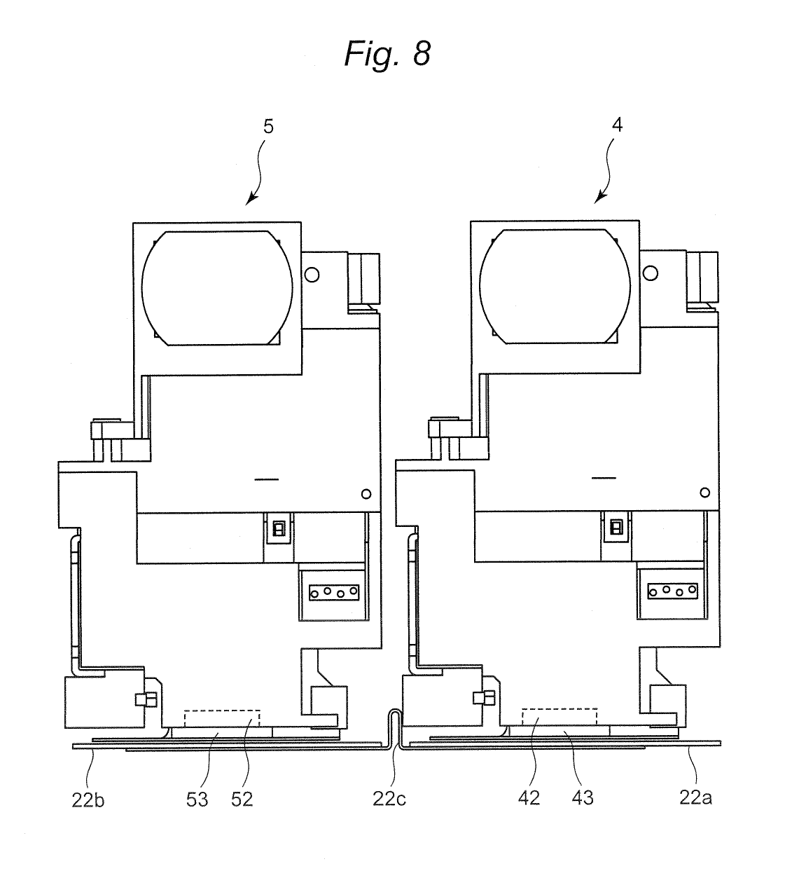

In the first embodiment, the radiation plate 22 as the thermally-conductive member is one plate composed of a single member. However, the present disclosure is not limited to this. Another example of the radiation plate 22 is described with reference to FIG. 8.

As shown in FIG. 8, the radiation plates 22a and 22b are joined to the image sensors 42 and 52 of the first imaging unit 4 and the second imaging unit 5, respectively. The radiation plates 22a and 22b are connected by a connecting member 22c having thermal conductivity and flexibility.

Examples of the connecting member 22c are a graphite sheet, a flexible wiring board on which solid filling of copper foil is formed, and thin aluminum foil having flexibility. Constitutions of the other parts are similar to the first embodiment.

Even such a constitution, similarly to the first embodiment, provides an effect such that the difference of temperature between the two imaging units 4 and 5 can be reduced, and the deterioration in the image quality of a stereoscopic image is prevented. Further, since the connecting member 22c has flexibility, the first imaging unit 4 and the second imaging unit 5 are mounted in manufacture of the digital camera, positions and directions of the first imaging unit 4 and the second imaging unit 5 are easily adjusted.

### 3. Third Embodiment

Still another constitution for uniformizing the temperatures of the first imaging unit 4 and the second imaging unit 5 is described.

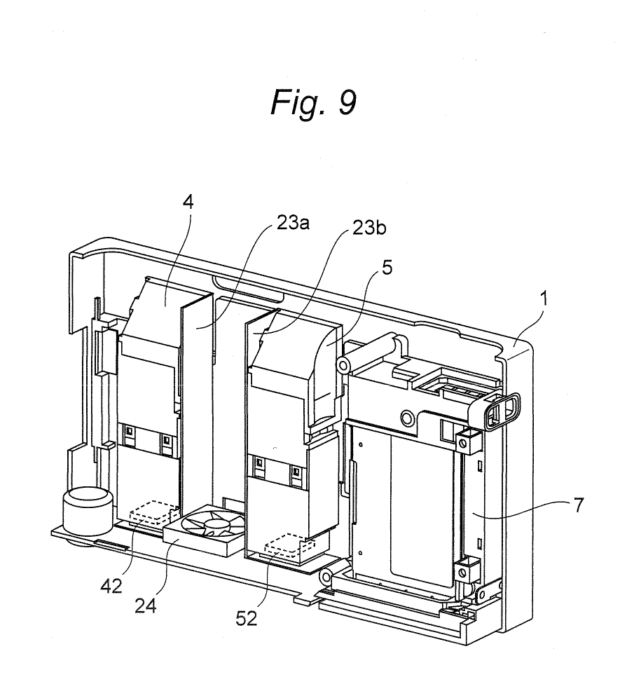

FIG. 9 is a perspective view illustrating an internal constitution of the digital camera according to a third embodiment. As shown in FIG. 9, the L-shaped radiation plates 23a and 23b are arranged on the image sensors 42 and 52. One End portions of the radiation plates 23a and 23b are thermally joined to the image sensors 42 and 52, and the other end portions are arranged along side surfaces of the imaging units and are arranged between the first imaging unit 4 and the second imaging unit 5. The radiation plates 23a and 23b are formed by, for example, aluminum. Further, a fan 24 for generating a current of air for cooling the radiation plates 23a and 23b are arranged between the radiation plates 23a and 23b in a lower part of the exterior case. Constitutions of the other units are similar to the first embodiment.

According to this embodiment, the current of air generated by the fan 24 simultaneously cools the two radiation plates 23a and 23b. As a result, the temperatures of the radiation plates 23a and 23b are uniformized, and the temperatures of the first imaging unit 4 and the second imaging unit 5 are uniformized.

The radiation plates 23a and 23b may be connected by the connecting member 22c having thermal conductivity and flexibility like the second embodiment.

The third embodiment, similarly to the first embodiment, also provides an effect such that the difference of temperature between the two imaging units 4 and 5 can be reduced, and the deterioration in the image quality of a stereoscopic image is prevented.

### 4. Fourth Embodiment

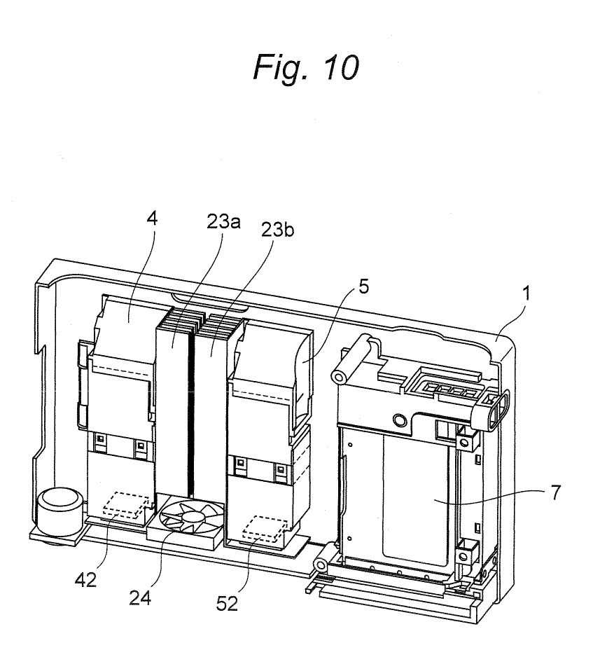

A fourth embodiment is described with reference to FIG. 10. FIG. 10 is a perspective view illustrating an internal constitution of the digital camera according to the fourth embodiment.

In the digital camera according to this embodiment, as shown in FIG. 10, fins are further provided to the radiation plates 23a and 23b as the thermally-conductive member described in the third embodiment. Constitutions of the other parts are similar to the third embodiment.

The digital camera according to the embodiment has the fins. Thus, a capacity of radiation of heat improves, thereby further improving the uniformizing of the temperatures of the first imaging unit 4 and the second imaging unit 5.

Even such a constitution, similarly to the first embodiment, can produce an effect such that the difference of temperature between the two imaging units 4 and 5 can be reduced, and the deterioration in the image quality of a stereoscopic image is prevented.

### 5. Another Embodiment

In the first to fourth embodiments, switching between capturing of a stereoscopic image and the capturing of a non-stereoscopic image is described as a factor of the difference of temperature between the two imaging units 4 and 5. However, the present disclosure is not limited to this. Suitably switching between a mode in which only one imaging unit is used and a mode in which both two imaging units are used may be assumed according to an operating system of the digital camera. For example, as the non-stereoscopic image capturing mode, both a mode in which only the first imaging unit 4 is used and a mode in which both the first imaging unit 4 and the second imaging unit 5 are used may be provided. The deterioration in the image quality of a stereoscopic image is caused by the difference of temperature between the two imaging units 4 and 5 caused by such switching between the modes. The present disclosure can be applied also to the deterioration in the image quality of a stereoscopic image.

In the digital camera according to the above embodiments, the two imaging units are provided, the present disclosure is not limited to this. The digital camera may have three or more imaging units. When the three or more imaging units are present, like the first embodiment, all the imaging units are connected by the radiation plates. In another manner, like third embodiment, the fan is arranged so that a current of air is generated between all the imaging units.

In the above embodiments, CMOS is used as the image sensor, but the present disclosure is not limited to this, and other image sensor such as CCD may be used.

In the above embodiments, the radiation plate 22 that thermally connects a plurality of the imaging units is formed by aluminum, but the radiation plate 22 may be formed by other materials or metal other than aluminum as long as they have thermal conductivity.

### INDUSTRIAL APPLICABILITY

The present disclosure is useful for preventing the deterioration in the image quality of a stereoscopic image generated by the imaging apparatus having the plurality of the imaging units.

What is claimed is:

1. An imaging apparatus, comprising:
a plurality of imaging units; and
a radiator operable to uniformize temperatures of the plurality of the imaging units.

2. The imaging apparatus according to claim 1, wherein the radiator is a thermally-conductive member for thermally connecting the plurality of the imaging units mutually.

3. The imaging apparatus according to claim 1, wherein the radiator has thermally-conductive members that are thermally joined to the plurality of the imaging units, respectively, and a connecting member which has flexibility and thermally connects the thermally-conductive members.

4. The imaging apparatus according to claim 1, wherein the radiator has thermally-conductive members that are thermally joined to the plurality of the imaging units, and a fan operable to generate a current of air between the plurality of the imaging units to simultaneously cool the thermally-conductive members.

5. The imaging apparatus according to claim 4, wherein fins are provided to the thermally-conductive members.
